(19) United States
(12) Patent Application Publication
(10) Pub. No.: US 2013/0238756 A1
(43) Pub. Date: Sep. 12, 2013

(54) SOCIAL COMPUTING SYSTEM

(71) Applicant: Pushkar MAHATTA, New Delhi (IN)

(72) Inventor: Pushkar MAHATTA, New Delhi (IN)

(21) Appl. No.: 13/459,794

(22) Filed: Apr. 30, 2012

(30) Foreign Application Priority Data
Mar. 6, 2012 (IN) 653/DEL/2012

(51) Int. Cl. G06F 15/16

(52) U.S. Cl. 709/218; 709/227

(57) ABSTRACT

The present invention relates to a social computing system which comprises an input channel to receive data from a source channel, a server to store a plurality of data, a processing device to compute said data into a set of output operations. The set of output operations comprise a floating motion of a plurality of users in a network, a means for linking one or more users to a point of interest in said network, a means for linking at least two users in said network and a means for following and physically attaching at least one user in said network. The present invention also relates to a method of social computing.

### CLAIM OF PRIORITY

This application claims priority to the patent application titled “A SOCIAL COMPUTING SYSTEM” filed in India, bearing Application Number 653/DEL/2012, filed on Mar. 6, 2012.

### FIELD OF TECHNOLOGY

The present invention generally relates to a global interactive platform and, more specifically, to a system and method of social computing worldwide in a virtual social environment.

### BACKGROUND

Currently, various applications for linking a plurality of users in the real and virtual space have been in practical use. For example, there is an application which associates a virtual tag with a fixed reference position on a map and further displays an image captured using a camera function of a terminal with a tag superimposed thereon (Ref: “Sekai Camera Support Center” (Internet URL: http://support.Sekaicamera.com/en). This application has a drawback of being heavy and thereby cannot be downloaded on communication devices, restricting operation in only a few devices, makes it inconvenient for the user to download the application. Moreover, the user has to invest more time to download. Further, the plurality of users in this application are clustered thereby dampening the interaction among users. Furthermore, the locations in the global map include all cities, states, countries and township, thereby making the process of social networking scattered and non-purposeful. Another application includes allowing a user to associate information such as a comment or a photograph with a position on a map and share the information or the map with a plurality of users (Ref: Japanese Patent Application Laid-Open No. 2006-209784 and “Google Maps” (Internet URL: http://maps.google.com/)).

Certain other social networking sites in use currently, for example “LinkedIn”, which allow a plurality of users to share professional, business contacts with other users. This decreases the confidentiality, which one or more users would prefer to maintain. Further “Twitter” involves the feature of following one or more users, but is only limited to the feature per se. One or more users “following” each other are unable to physically attach and perform activities together in this form of social networking environment.

Some systems in the State-of-the-Art allow a user to import or reuse his contact list or electronic mail (email) address book, and to utilize such contacts and email addresses thereafter for creation of a virtual social network. This mechanism highly limits the boundaries set forth by the user to interact with others in the global network. Subsequently, this may not allow the user to create a virtual social network with person's unknown to the user, existing in the globe and who might be in the domain of interest of the user.

Also, U.S. Pat. No. 7,895,208 B2, “Device, System, and Method of Creating Virtual Social Networks Based on Web-Extracted Features discloses the movement of a cluster of users associated with a particular place to new destinations according to the choice of users. But, it fails to create a virtual social networking on a widespread global platform.

In light of the above drawbacks in the State-of-the-art, there is a need for providing a system, which is user-friendly and can facilitate interaction of a plurality of users in a global platform.

### SUMMARY

An object of the present invention is to provide a system for social computing in order to link a plurality of users in a global network. Another object of the present invention relates to a method of social computing.

The present invention is a user-friendly system, wherein the user can easily download the application on a communication device. Also, it provides a feature of float, which facilitates the interaction of random people across the globe. Floating of a plurality of users in this system is non-clustered, thereby facilitating easy viewing and communication of the plurality of users in float motion and further their interaction. Moreover, the invention also provides a feature of transport, to enable a plurality of users to travel across the various locations across the globe. Transport history enables viewers to have a glimpse of the locations visited by them previously. The locations have been suitably curated in order to remove excess of unnecessary locations, which would add weight to the system. In this system plurality of users can be linked to each other physically by the option of attaching and can travel distant locations for business or exchanging pleasantries. Privacy settings prevent the viewing of contacts and maintaining confidentiality of users irrespective of being attached together. The plurality of users travel in locations, which have a real time appeal to it, even though they are interacting in a virtual social networking environment.

In various embodiments of the present invention, the system of social computing comprises an input channel to receive data from a source channel, a server to store a plurality of data and a processing device to compute said data into a set of output operations. The output operations further comprise a floating motion of a plurality of users in a network, a means for linking them to earth in said network, a means for linking at least two users in said network and further providing a means for following and physically attaching at least one user in said network.

In accordance to an embodiment of the present invention, the source channel comprises data from one or more web-based servers.

In an embodiment of the present invention, the plurality of data stored in said network comprises a feature of transport, a feature of float history of said plurality of users.

In yet another embodiment of the present invention, the transport of said plurality of users is in the floating motion in said network.

In still another embodiment of the present invention is the feature of float history is capable of revealing one or more locations visited by the plurality of users in said network. The network according to an embodiment of the present invention includes a global map in a two dimensional format, wherein the global map includes feel of real-time locations worldwide.

According to an embodiment of the present invention comprises a feature of following, wherein said feature includes physical attachment and motion of one or more users floating in said network and further, following city news in said network. In accordance with an embodiment of the present invention, the present invention also comprises a feature of detaching one user from the second user when at least two users are following each other in said network.

In another embodiment of the present invention, the feature of following one or more users in said network by physical attachment comprises exchanging gifts, pleasantries and extending business contacts, wherein said plurality of users get a feel of real-time locations worldwide.

In accordance with an embodiment of the present invention, the feature of following one or more users in said network involves privacy settings.

In another embodiment of the present invention, the plurality of data stored on the source channel includes attaching a virtual tag. The virtual tag is further associated with locations in said network.

Another aspect of the present invention is to link one or more users to a point of interest and to each other in said network by a means called threading.

Yet another aspect of the present invention is to download said social computing system on at least one communication device.

In accordance to the various embodiments of the present invention, the plurality of users are connected to one or more random users worldwide in the floating motion. To enable traveling of the plurality of users from a destination involves a converting unit. Said converting unit further operates by changing the X and Y coordinates along the earth's latitude and longitude to enable transport of one or more users to a location of their choice in at least one location in the global map.

In accordance with the various embodiments of the present invention, the method of social computing involves the steps of receiving data from one or more web based servers, thereafter, processing said data to perform said output operations and further communicating with a plurality of users, thereby displaying a gamut of content in a downloadable format, further acquiring data from said global map, attaching and detaching one or more users in said network and lastly, transporting one or more users in said network.

In accordance with an embodiment of the present invention, one or more users communicate to one another by messaging text, pictures, links, posts and updating news items by threading.

Another aspect of the present invention is to provide said converting unit for facilitating the users to reach the desired location in said global map.

In accordance with an embodiment of the present invention, the method of social computing involves connecting one or more users by a means for floating in randomized non-clustered motion in said network.

In accordance with an embodiment of the present invention, the method of social computing involves connecting one or more users by threading.

Further, another aspect of the method of social computing is to provide an imagery system which displays the imagery content in said network and wherein the imagery system is “World Float”

Also, an object of the present invention is to provide a computer readable media used for performing a process in said network, wherein the process comprises storing a plurality of said data from one or more web based servers in said network and to further process said data in order to provide a plurality of services and carry out a series of operations amongst one or more users in said network.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 illustrates an example of social computing system architecture of a server-based World Float Environment according to various aspects in accordance with the present system.

FIG. 2 illustrates an embodiment of the social computing system wherein one or more World Float Activities include updating and sharing city news amongst a plurality of users.

FIG. 3 illustrates an aspect of social computing system wherein one or more World Float Activities include following one or more users and registering float history in accordance with the present invention.

FIG. 4 illustrates another aspect of social computing system wherein one or more World Float Activities include transport of a plurality of users to one or more destinations across the globe.

FIG. 5 illustrates an environment of social computing system wherein a plurality of users are in a floating motion.

FIG. 6 illustrates an environment wherein various aspects of a plurality of users in activity are displayed in the social computing system.

FIG. 7. is a schematic representation of components in a social computing system coupled to one or more servers, according to an illustrative embodiment of the invention.

FIG. 8. is a flowchart of the social computing method in accordance with various exemplary embodiments of the present invention.

### DETAILED DESCRIPTION

In the following detailed description, numerous specific details are set forth in order to provide a thorough understanding of some embodiments of the invention. However, it will be understood by persons skilled in the art that embodiments may be practiced without any specific details. In other instances, well-known methods, procedures, components and/or systems have not been described in detail so as not to obscure the discussion.

Discussions herein utilizing terms such as, for example, “receiving”, “processing”, “communicating”, “displaying”, “acquiring”, “attaching”, “transporting”, or the like, may refer to process (es) of a computer. A computing system is provided for manipulating/ processing data represented by physical quantities within the computer's memory into another data, which is stored in the storage medium of the computer in order to perform output operations or processes.

It will be appreciated that the embodiments of the invention hereinbefore described are given by way of example only, and are not meant to limit the scope of the invention in any way.

A Worldfloat imagery system or an interface includes an upper body (a) and a lower body (b). The upper body (a) comprises a world float environment with a float motion of the float objects as explained by way of diagrams, drawings and figures. The lower body of the interface is a home page of one or more users and provides one or more users with the facility of private messaging, sharing city news, city photos, city videos, and like content, following at least two users, searching a plurality of cities, a gamut of data and sharing one or more data on at least one profile of a plurality of users across the globe. The combination of world and cities floating environment forming a part of the upper body and the home page below forming a part of the lower body, is a well coordinated and unified social computing system in the World float imagery system as a whole.

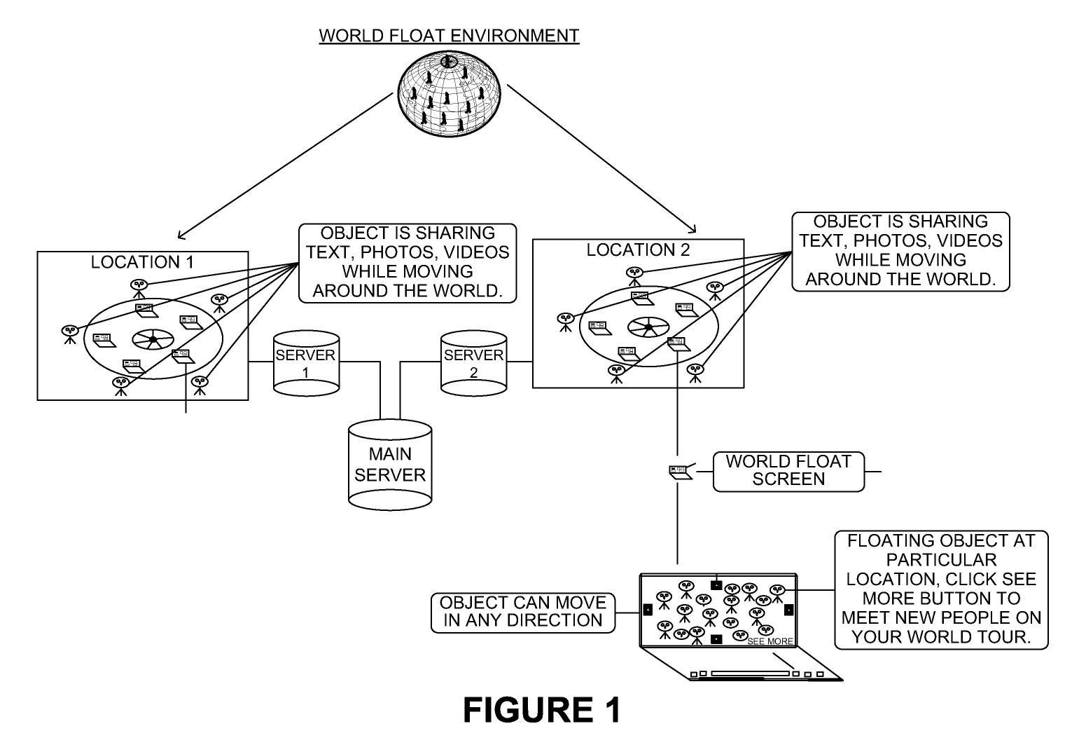

FIG. 1. illustrates an example of social computing system architecture of a server-based World Float Environment according to various aspects in accordance with the present system. A plurality of users in a location 1 are able to share text, photos, videos while moving around the world with one or more users in a location 2 wherein the plurality of users in location 1 and one or more users in location 2 are connected by a main server. The main server is connected with server 1, which works in conjunction with the plurality of users residing in location 1. The main server is connected with server 2, which works in conjunction with one or more users residing in location 2. One or more data acquired from the main server is divided into server 1 and server 2, wherein at least one server (server 1) uploads information of a plurality of objects residing in location 1, selected from sharing text, photos, videos while moving around the world and another server (server 2) uploads information of one or more objects residing in location 2, selected from sharing text, photos, videos while moving around the world. The data acquired from the sharing activity of one or more users appears on a World Float Screen wherein the plurality of objects are free to move in any direction. The plurality of floating objects in at least one location can meet one or more new objects in another location by clicking “See More” button when the plurality of floating objects are on a world tour.

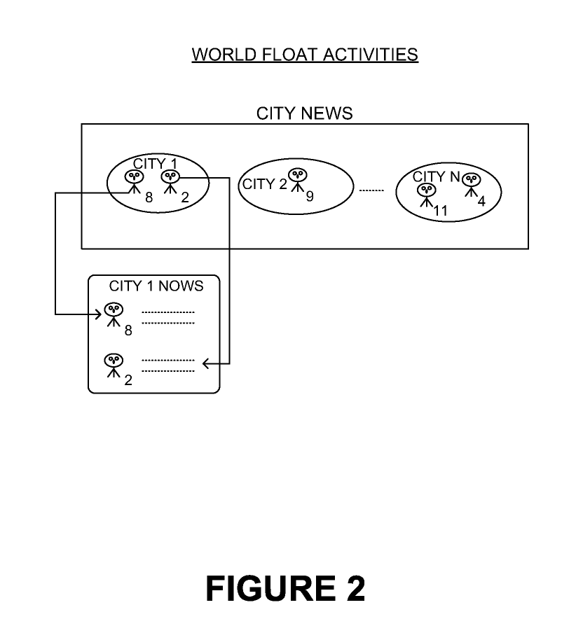

FIG. 2. illustrates an embodiment of the social computing system wherein one or more World Float Activities include updating and sharing city news amongst a plurality of users. According to an embodiment of the present invention, object 2 is able to share and update city news with object 8. Also, the city news can be shared amongst a plurality of objects such as object 9 in city 2 with object 11 and object 4 in city n with object 8 and object 2 in city 1.

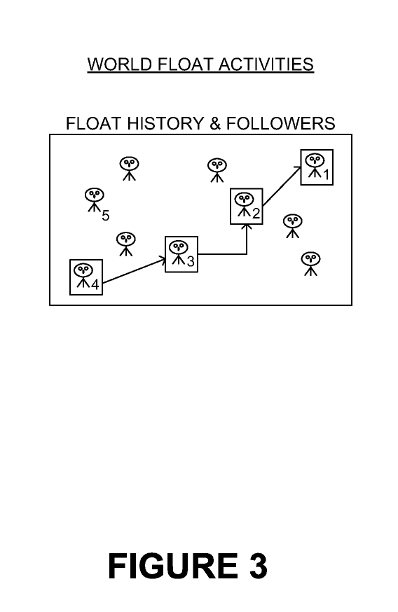

FIG. 3. illustrates an aspect of social computing system wherein one or more World Float Activities include following one or more users and registering float history in accordance with the present invention. In accordance with an embodiment of the present invention, object 1 can follow either object 2 or object 3 or object 4 or object 5 in a network or vice versa. The network in said system also provides a provision of attaching an object 1, object 2, object 3, object 4 and object 5 together. The objects move physically together in the social computing system. The objects are in a randomized non-clustered floating motion. Once one or more objects follow each other, they are capable of exchanging gifts, pleasantries and extending business contacts in a virtual environment, which has an appeal of a real-time environment. A feature of “detaching” allows one or more users to detach from each other so prevent their physical movement across the globe. In accordance with an embodiment of the present invention, location of one or more objects is registered in an option of “float history”. One or more objects can return to any location previously visited by them in said social computing system. This feature provides one or more objects to revisit the places visited previously, forming a part of the float history memory.

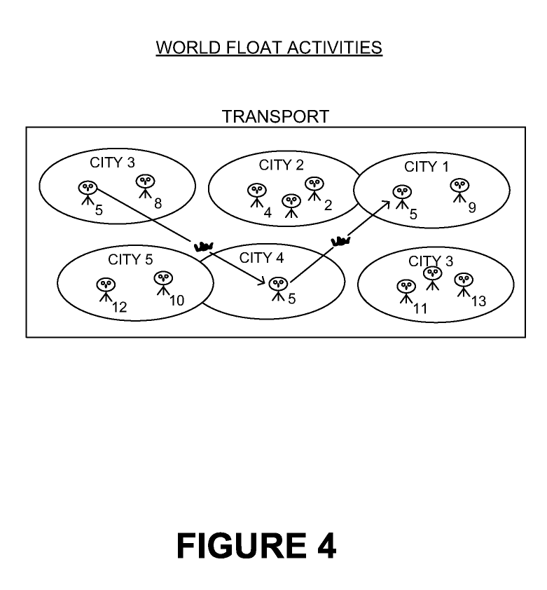

FIG. 4 illustrates another aspect of social computing system wherein one or more World Float Activities include transport of a plurality of users to one or more destinations across the globe. Object 5 in city 3 is capable of moving to city 4 and thereafter to city 1. Also, other objects (12, 10, 11, 13, 9, 4, 2) can move from their respective cities or locations throughout the globe to various other locations worldwide. The feature of “transport” enables one or more users to travel to varied unseen locations in the global map.

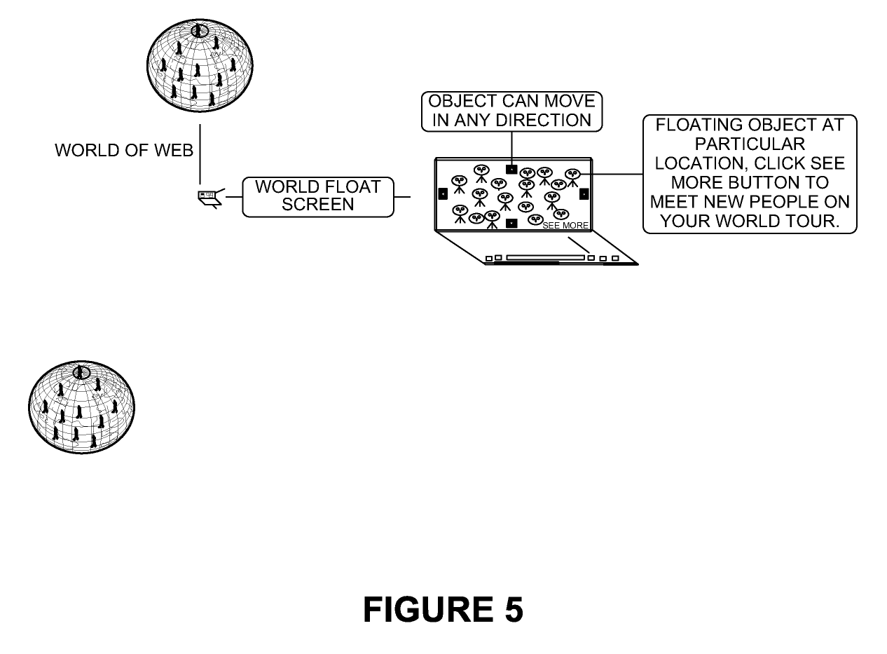

FIG. 5. illustrates an environment of social computing system wherein a plurality of users are in a floating motion. In various embodiments of the present invention, the World Float Screen has a world of web in its two dimensional backdrop and a plurality of objects are capable of moving in any direction. Also, the social computing system allows one or more objects to meet one or more new people by clicking a “See More” button, while one or more objects are on a world tour. The floating motion in the World Float Screen is defined as a feeling of motion of one or more floating objects. This floating motion invokes a feeling and emotion of movement to create a float environment and thereby provide a real-time appeal to the plurality of users in a virtual social computing environment. According to one aspect of the present invention, the real-time appeal is adjusted to server speeds in various countries. Further, it should be appreciated that even though the background is static, the float motion is real-time appeal and one or more new users can be viewed by clicking a “see more people button”. Since, the users are refreshed once this button is clicked, it enables networking of at least two unknown users across the globe.

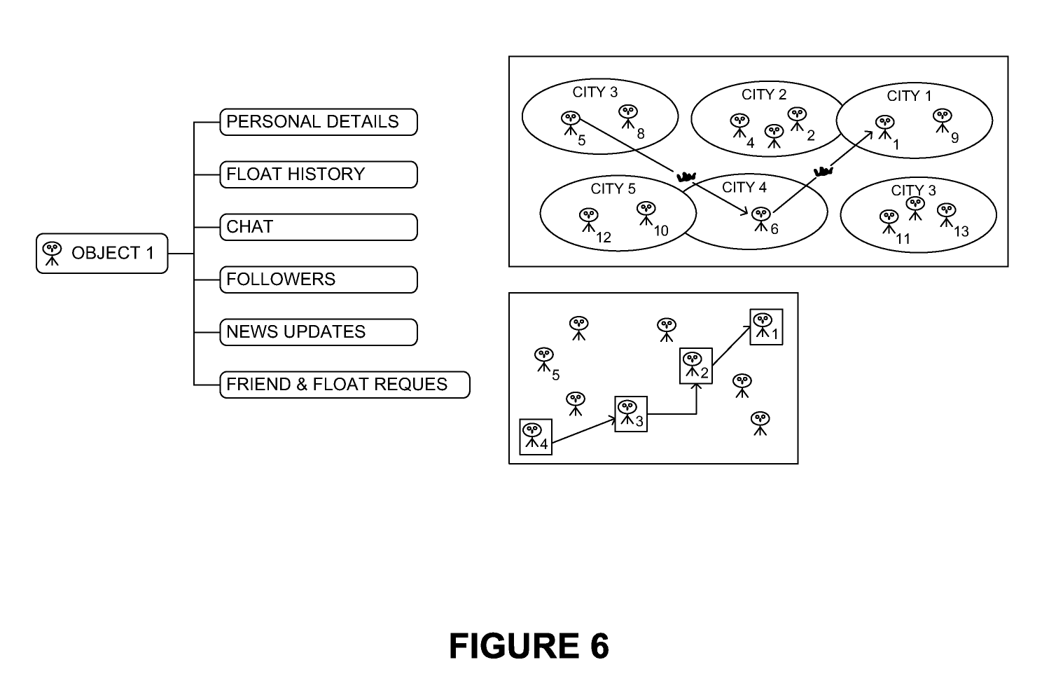

FIG. 6. illustrates an environment wherein various aspects of a plurality of users in activity are displayed in the social computing system. Various aspects of an object in the social computing system include 1) Personal Details 2) Float History 3) Chat 4) Followers 5) News Updates 6) Friend & Float Request. One or more objects can share the above mentioned aspects while floating in the social computing system throughout the globe. Object 5 belonging to city 3 can share details of the above mentioned aspects with object 6 residing in city 3 and subsequently share details with object 1 belonging to city 1. Object 4 can share details including 1) Personal Details 2) Float History 3) Chat 4) Followers 5) News Updates 6) Friend & Float Request with object 3 and further object 3 can share its details with object 2 and further with object 1 residing in either the same city or in separate cities globally.

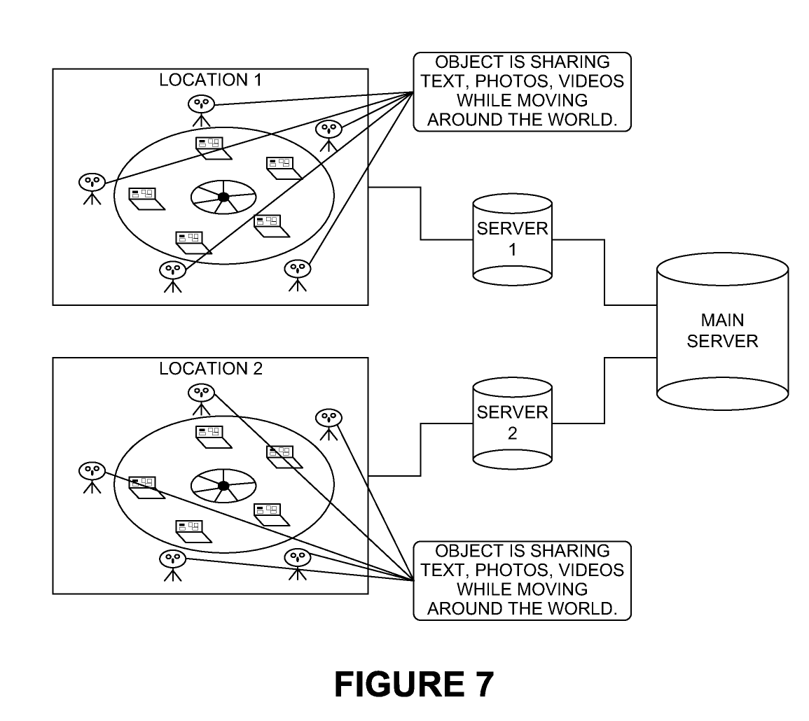

FIG. 7. is a schematic representation of components in a social computing system coupled to one or more servers, according to an illustrative embodiment of the invention. According to an embodiment of the present invention, data is taken from a main server into two servers: server 1 and server 2. Server 1 uploads data in a social computing system wherein plurality of objects are in activity in location 1. The plurality of objects can share text, photos, and videos amongst themselves and also with other objects situated in location 2. Server 2 uploads data in a social computing system wherein a plurality of objects are in activity in location 2. The plurality of objects can share text, photos, and videos amongst themselves and also with other objects residing in location 1.

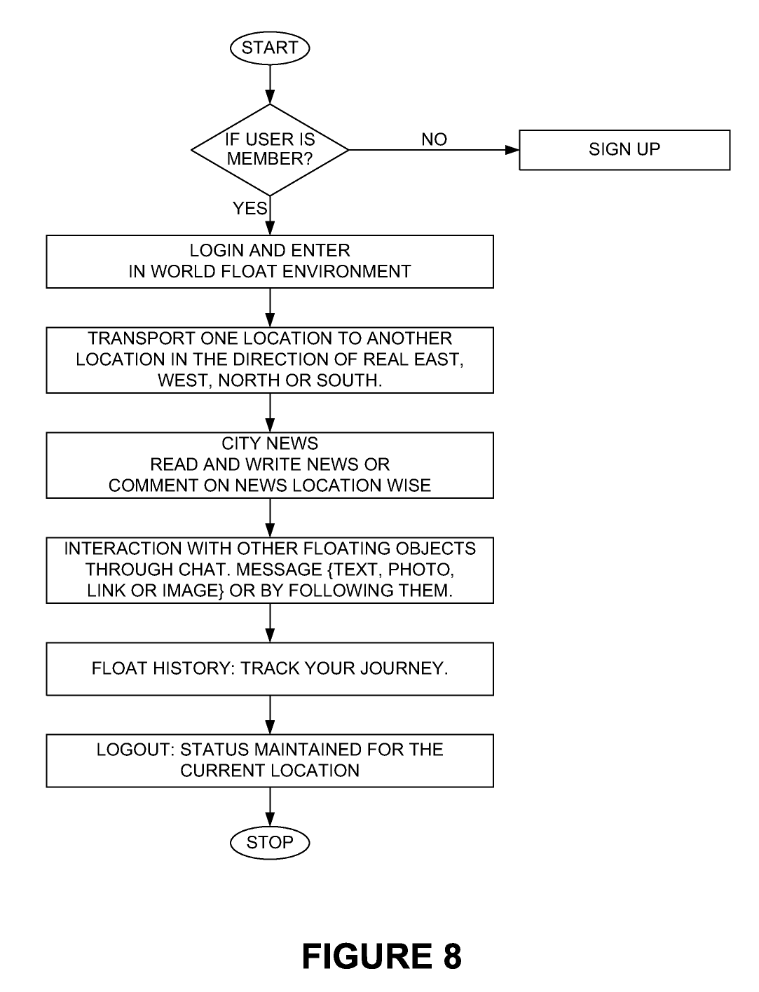

FIG. 8. is a flowchart of the social computing method in accordance with various exemplary embodiments of the present invention. One or more user starts by signing up in the social computing system. Once the user has already signed in the system, the user is designated as a member of the system. A member once logged in, enters in World Float Environment. One or more users are transported to another location in the direction of approximate East, West, North or South wherein individual direction control of each floating object is correlated to earth's geography and the process is termed as “synthesis” in the World Float Environment. One or more users are capable of reading, writing and sharing City News across the globe. According to one aspect, the city news has a voting system wherein one or more members of the system rank city and worldwide news. According to an embodiment of the present invention, one or more users are capable of commenting on news location wise. At least two objects interact with other objects through chat, message (text, photo, link or image) or by following them. In accordance with an embodiment of the present invention, the feature of float history enables one or more users to track the journey of users. After engaging in various activities in the social computing system, the user logs out of the system and maintains the status for the current location. Once the user has logged out of the system, the social computing process stops till the user again signs up in the system.

Functions, operations, components and/or features described herein with reference to one or more embodiments, may be combined with, or may be utilized in combination with, one or more functions, operations, components and/or features described herein with reference to one or more other embodiments, or vice versa.

While certain features of some embodiments of the invention have been illustrated and described herein, many modifications, substitutions, changes, and equivalents may occur to those skilled in the art. It is therefore, to be understood that the appended claims are intended to cover all such modifications and changes.

What is claimed is:

1. A social computing system comprising:
an input channel to receive data from a source channel;
a server to store a plurality of data;
a processing device to compute said data into a set of output operations;
the set of output operations comprising:
a floating motion of a plurality of users in a network;
a means for linking one or more users to a point of interest in said network;
a means for linking at least two users in said network; and
a means for following and physically attaching at least one user in said network.

2. The social computing system as claimed in claim 1, wherein the source channel comprises data from one or more web-based servers.

3. The social computing system as claimed in claim 1, wherein the plurality of data stored on the source channel comprises a feature of transport, a feature of float history of said plurality of users.

4. The social computing system as claimed in claim 3, wherein the transport of said plurality of users is in the floating motion in said network.

5. The social computing system as claimed in claim 3, wherein the feature of float history is capable of revealing the locations visited by the plurality of users in said network.

6. The social computing system as claimed in claim 1, wherein the network includes a global map in a two dimensional format.

7. The social computing system as claimed in claim 1, wherein the global map includes real-time locations worldwide.

8. The social computing system as claimed in claim 1, wherein the plurality of data stored on the source channel comprises a feature of following.

9. The social computing system as claimed in claim 8, wherein said feature of following includes physical attachment of one or more users floating in said network and following city news of a plurality of users in said network.

10. The social computing system as claimed in claim 8, wherein said feature of following one or more users in a network by physical attachment comprises exchanging gifts, pleasantries and extending business contacts in real-time locations worldwide.

11. The social computing system as claimed in claim 8, wherein said feature of following one or more users in said network involves privacy settings.

12. The social computing system as claimed in claim 1, wherein said plurality of data stored on the source channel includes attaching a virtual tag.

13. The social computing system as claimed in claim 12, wherein the virtual tag is associated with locations in the network.

14. The social computing system as claimed in claim 1, wherein said means of linking one or more users to the point of interest and linking at least two users in said network involves threading.

15. The social computing system as claimed in claim 1, wherein the plurality of data stored on the source channel comprises a feature of detaching one user from the second user when at least two users are following each other.

16. The social computing system as claimed in claim 1, wherein said social computing system can be downloaded on at least one communication device.

17. The social computing system as claimed in claim 1, wherein the plurality of users are connected to one or more random users worldwide in the floating motion.

18. The social computing system as claimed in claim 17, wherein the floating motion of users is non-clustered.

19. The social computing system as claimed in claim 1, wherein a converting unit determines the positioning of one or more users in said network.

20. The social computing system as claimed in claim 19, wherein said converting unit involves changes in X and Y coordinates along the earths latitude and longitude to enable transport of one or more users to a location of their choice and in at least one direction included in the global map.

21. A social computing method comprising:
receiving data from one or more web based servers;
processing said data to perform said output operations;
communicating with a plurality of users;
displaying a gamut of content in a downloadable format;
acquiring data from global map;
attaching and detaching one or more users in said network; and
transporting one or more users in said network.

22. The social computing method as claimed in claim 21, wherein one or more users communicate by messaging text, pictures, links, posts and updating news items by threading.

23. The social computing method as claimed in claim 21, wherein an imagery content is displayed in the two dimensional or three dimensional format.

24. The social computing method as claimed in claim 21, wherein a plurality of users reach the desired location in said global map by the feature of said converting unit.

25. The social computing method as claimed in claim 21, wherein one or more users are connected by a means for floating in randomized non-clustered motion in said network.

26. The social computing method as claimed in claim 21, wherein one or more users are connected with threading.

27. The social computing method as claimed in claim 21, wherein an imagery system displays the imagery content in said network.

28. The social computing method as claimed in claim 21, wherein said imagery system is World Float.

29. A computer readable media used for performing a process in said network, wherein the process comprising:
storing a plurality of said data from one or more web based servers in said network; and
processing said data to provide a plurality of services and carry out a series of operations amongst one or more users in said network.
